(19) United States
(12) Patent Application Publication
(10) Pub. No.: US 2025/0283984 A1
(43) Pub. Date: Sep. 11, 2025

(54) LIDAR SENSOR AND VEHICLE

(71) Applicant: Robert Bosch GmbH, Stuttgart (DE)

(72) Inventors: Sebastian Schweyer, Groebenzell (DE); Kai Worms, Hardthausen Am Kocher (DE); Vitali Obholz, Ostfildern (DE); Daniel Stricker-Shaver, Marnheim (DE); Remigius Has, Grafenau-Daetzingen (DE)

(21) Appl. No.: 19/049,319

(22) Filed: Feb. 10, 2025

(30) Foreign Application Priority Data
Mar. 8, 2024 (DE) 10 2024 202 196.2

(51) Int. Cl. G01S 7/4865; G01S 7/481; G01S 7/484; G01S 7/486

(52) U.S. Cl. CPC G01S 7/4865; G01S 7/4813; G01S 7/484; G01S 7/4868

(57) ABSTRACT

A lidar sensor. The lidar sensor includes a transmitting unit, a receiving unit, a protective window, a housing, and an evaluation unit. The transmitting unit generates a laser pulse which is emitted into an environment, the receiving unit receives through the protective window portions of the emitted laser pulse reflected in the environment, and generates a signal corresponding to the reflected portions of the laser pulse. The evaluation unit puts the receiving unit into a first receiving mode before receiving partial reflections of a particular laser pulse, which are caused within the lidar sensor by the protective window, puts the receiving unit into a second receiving mode at a predefined time interval from the emission of the laser pulse, receives the generated signal, and distinguishes first signal components generated by partial reflections on the protective window from second signal components generated by reflections on objects in the environment.

### CROSS REFERENCE

The present application claims the benefit under 35 U.S.C. § 119 of German Patent Application No. DE 10 2024 202 196.2 filed on Mar. 8, 2024, which is expressly incorporated herein by reference in its entirety.

### FIELD

The present invention relates to a lidar sensor and to a vehicle with such a lidar sensor.

### BACKGROUND INFORMATION

Lidar sensors are described in the related art and may be used, for example, in environmental detection systems of vehicles in order to operate, for example, driver assistance systems and/or systems for an automated driving operation, etc. on the basis of the environmental information detected.

Such lidar sensors usually have a protective glass, through which an interior of the lidar sensors is protected from moisture, dirt, damage, etc. due to environmental influences and which functions as an exit and entry surface for measurement signals (i.e., for laser pulses) of the lidar sensor.

Although the protective window is substantially transparent to laser light generated by the lidar sensor, deposits on the protective glass and/or surface defects of the protective glass (e.g., scratches) can lead to unwanted partial reflections of the laser light within the lidar sensor.

Depending on a strength of such partial reflections and a configuration of a detector of the lidar sensor, such partial reflections can cause saturations within pixels of a photodetector of the lidar sensor, which can at least partially overlap laser pulse echoes generated by objects in the environment of the vehicle, so that detection of objects in the immediate environment of the lidar sensor may be limited or prevented.

Different methods are therefore used in the related art to distinguish between such unwanted partial reflections and reflections of actual objects in the environment of the lidar sensor. For example, variable threshold adjustment or echo separation algorithms can be used, which work on the basis of superimposed signal components from the partial reflections of the protective window and actual object echoes.

PCT Patent Application No. WO 2021/258111 A1 describes a lidar system, which is configured to increase a bias voltage of one or more photodetectors after activation of a light emitter of the lidar system, wherein the increase in the bias voltage occurs depending on a time that has passed since the activation of the light emitter.

### SUMMARY

According to a first aspect of the present invention, a lidar sensor, in particular a lidar sensor for a vehicle, is provided, wherein the lidar sensor is preferably a time-of-flight lidar sensor, which is configured to ascertain distances to objects in the environment of the lidar sensor on the basis of a measurement of times of flight of an emitted laser light.

According to an example embodiment of the present invention, the lidar sensor has at least a transmitting unit, a receiving unit, a protective window, a housing, and an evaluation unit, wherein the transmitting unit has, for example, one or more laser diodes, wherein the protective window is made, for example, of glass and/or of a transparent plastics material, and wherein the evaluation unit is designed, for example, as an ASIC, FPGA, processor, digital signal processor, microcontroller, or the like.

The transmitting unit and the receiving unit are arranged within the housing, and the protective window is integrated into a cutout in a wall of the housing. The protective window thus forms an optical interface between an interior of the lidar sensor and an environment of the lidar sensor in order to protect components arranged in the interior of the lidar sensor from environmental influences such as humidity and dirt.

According to an example embodiment of the present invention, the transmitting unit is designed to generate a laser pulse which, for the purpose of detecting an environment of the lidar sensor, is emitted through the protective window into the environment. It should be noted that a shape of a time curve of the laser pulse is not restricted to a specific shape, and in particular not to a shape of a rectangular pulse, and instead can basically have any shape. Each transmission process for transmitting corresponding laser pulses is initiated, for example, by the evaluation unit and/or a different component of the lidar sensor (e.g., by the transmitting unit itself).

According to an example embodiment of the present invention, the receiving unit is configured to receive through the protective window, by means of a detector (specifically a photodetector), portions of the emitted laser pulse reflected in the environment, and to generate a signal (in particular an electrical signal) corresponding to the reflected portions of the laser pulse. For this purpose, a spectral sensitivity of the detector is advantageously substantially adjusted to a wavelength of the emitted laser pulse. A surface of the detector is preferably composed of a plurality of light-sensitive pixels, wherein a number of pixels and an arrangement of the pixels are basically not restricted and are advantageously determined depending on a particular design and/or a particular intended use of the lidar sensor (e.g., as a one-dimensional pixel arrangement, as a two-dimensional pixel arrangement, etc.).

According to an example embodiment of the present invention, the evaluation unit, which is connected to the receiving unit by information technology, is configured to put the receiving unit into a first receiving mode before receiving partial reflections of a particular laser pulse, which are caused within the lidar sensor by the protective window. Such partial reflections can have a disruptive effect on the environmental detection by the lidar sensor since they can lead to undesirable saturation in the detector and to the associated overlap of echoes from objects (i.e., of portions of the laser pulse reflected on objects in the environment of the lidar sensor), which makes detection of objects significantly less reliable or even impossible, in particular in a close range of the lidar sensor. Such a close range corresponds, for example, to a range up to a distance of 20 m, 10 m or less from the lidar sensor.

The partial reflections can in particular occur when a light transmittance of the protective window is partially or completely impaired, for example due to deposits on a side of the protective window facing the environment of the lidar sensor, wherein such deposits can include dirt particles and/or water droplets, etc. Alternatively or additionally, it is possible that such impairment of the protective window can be caused by damage to the surface of the protective window, which can occur, for example, in the form of scratches. It is therefore likely that the above-described partial reflections on the protective window will increase with increasing service life of the lidar sensor due to expected increasing damage. In addition, the larger an angle between a transmission path of the lidar sensor and the protective window or between a reception path of the lidar sensor and the protective window is, the more strongly such partial reflections can occur.

According to an example embodiment of the present invention, the evaluation unit is furthermore configured to put the receiving unit into a second receiving mode at a time interval, which may be a predefined time interval and/or a dynamically adjusted time interval, from the emission of the laser pulse, wherein the receiving unit has a lower light sensitivity in the first receiving mode than in the second receiving mode. By appropriately setting the respective light sensitivity in the first receiving mode and in the second receiving mode, a disadvantageous superimposition of useful echoes (i.e., echoes generated by objects in the environment of the lidar sensor) by partial reflection echoes (i.e., echoes generated on the protective glass in the interior of the lidar sensor) can be reduced or completely avoided. In this way, the probability of distinguishing the useful echoes from the partial reflection echoes can be increased.

The evaluation unit is also configured to receive the signal generated by the receiving unit and to distinguish first signal components generated by partial reflections on the protective window from second signal components within the signal, which are generated by reflections on objects in the environment of the lidar sensor. For distinguishing between the respective signal components, conventional methods from the related art for identifying the respective signal components (e.g., by comparing them with suitable threshold values) and/or different methods can be used.

The identified signal components generated by useful echoes can subsequently be provided, for example, to a component that is able to ascertain distances and/or sizes of objects in the environment of the lidar sensor on the basis of these signal components. The signal components are provided, for example, by means of the evaluation unit and/or a different component of the lidar sensor.

The lidar sensor according to the present invention thus offers the particular advantage that interference caused by partial reflection echoes can be reduced or avoided, which makes it possible to detect objects even in the close range of the lidar sensor or increases a reliability of detecting objects in the close range.

It should be noted that switching between the first receiving mode and the second receiving mode can be implemented directly or by using a predefined temporal transition between the receiving modes with one or more intermediate stages between the two receiving modes. Alternatively, it is also possible to carry out such a temporal transition continuously.

It should also be noted that, in addition to adjusting the light sensitivity depending on the useful echoes or partial reflection echoes present, it is possible to adjust the transmission power of the transmitting unit by means of a suitable control, for example by the evaluation unit, in order to further reduce or to avoid saturation or overloading of the detector due to the reception of the partial reflection echoes.

Preferred developments and example embodiments of the present invention are disclosed herein.

In an advantageous example embodiment of the present invention, the detector of the receiving unit is a SPAD (single photon avalanche diode)-based detector, which makes a particularly high sensitivity and/or range possible when detecting the environment by means of such a lidar sensor. In addition, a SPAD-based detector offers particularly high flexibility in setting suitable first and second light sensitivities. Alternatively or additionally, the lidar sensor is designed as a point scanner and/or as a line scanner and/or as a flash sensor.

In a further advantageous example embodiment of the present invention, the time interval from the time of emitting the laser pulse is set depending on a time of flight of the laser pulse, which results from a length of an optical path from the transmitting unit to the protective window and from the protective window to the receiving unit. Alternatively or additionally, the time interval is set depending on a duration and/or a curve and/or an amplitude of the laser pulse. Since the evaluation unit knows the time at which the laser pulse is emitted, the time for switching from the first receiving mode to the second receiving mode can be ascertained accordingly by the evaluation unit and the switching process can be initiated at the ascertained time or at a time which has a predefined time offset from the ascertained time. The time at which the laser pulse is emitted can be provided to the evaluation unit via the transmitting unit and/or another component of the lidar sensor. Alternatively or additionally, it is possible for the emission of the laser pulse to be initiated by the evaluation unit itself, so that the time of emission can be ascertained on the basis of the initiation. The aforementioned predefined offset can advantageously be adjusted to a duration and/or a time curve of the laser pulse so that the switching process between the sensitivity modes only takes place, for example, at a time when the laser pulse is in a region of a falling edge of the laser pulse, in order to ensure that saturation due to switching too early does not occur in the detector.

Advantageously, according to an example embodiment of the present invention, the evaluation unit is configured to operate all or some of the pixels of the detector, in the first receiving mode, in a non-amplified operating mode, in a linear operating mode, in the Geiger operating mode (i.e., above a breakdown voltage of photodiodes of the detector, wherein the Geiger operating mode represents a single photon detection) or in a mixed operating mode and/or to operate them, in the second receiving mode, in the mixed operating mode or in the Geiger operating mode. The mixed operating mode is understood to mean an operating mode in which a bias voltage (in particular a reverse bias voltage) is applied by photodiodes of the detector in the region of the breakdown voltage so that, from a statistical point of view, some of the photodiodes (i.e., the receiving pixels) are in the linear operating mode and some are in the Geiger operating mode. In addition, it is possible to evaluate each detector pixel of the detector individually and/or to define predefined groups of detector pixels as macropixels, the individual received signals thereof are combined to produce a resulting overall signal in each case. In an exemplary embodiment, the detector is configured by means of the evaluation unit such that it operates in the linear operating mode in the first receiving mode and in the Geiger operating mode in the second receiving mode. Alternatively, it is possible that the detector operates in the mixed operating mode in the first receiving mode and in the Geiger operating mode in the second receiving mode. In addition, it is possible to use the photodiodes in the non-amplified operating mode in the first mode, so that the partial reflections lead to no or only a small amplitude in the corresponding signal components. This makes it possible to achieve a particularly reliable separation of the useful echoes from the partial reflection echoes. In addition, any other combinations of operating states in the first and second receiving modes are possible, which can preferably be set depending on a design of the lidar sensor and/or current boundary conditions and/or a current use of the lidar sensor.

Particularly advantageously, according to an example embodiment of the present invention, the evaluation unit is configured to switch from the first receiving mode to the second receiving mode when amplitude values of a falling edge of the first signal components of the laser pulse, which are reflected by the protective window, fall below a predefined threshold value. This offers the particular advantage that the switching time is adjusted depending on the current boundary conditions. In an exemplary case, in which a surface quality of the protective window deteriorates over the service life of the lidar sensor due to damage and a higher proportion of partial reflections on the protective window is thus to be expected, which can cause a higher saturation in the detector, it can be assumed that a temporally changed (e.g., extended) overlap of useful echoes with partial reflection echoes occurs. By using the threshold value to determine the switching time between the receiving modes, the switching time can advantageously be adjusted to changing boundary conditions, thus ensuring a reliable distinction between useful echoes and partial reflection echoes despite changed boundary conditions.

Furthermore advantageously, according to an example embodiment of the present invention, the lidar sensor is configured to maintain a respective predefined light sensitivity in the first receiving mode and/or in the second receiving mode by means of a control, for example by controlling the amplitudes of the respective signal components by adjusting the respective bias voltages of the photodiodes to respective corresponding target values (e.g., maximum permissible amplitude values). Such a control is particularly advantageous since the respective light sensitivities can be set or maintained particularly precisely in this way. For example, even slight changes in temperature can cause the light sensitivities set by means of the respective bias voltages to change in an undesirable manner. Furthermore, such a control offers the advantage that a degree of impairment of a light transmittance of the protective window can be ascertained on the basis of the extent of the control. Such information on the degree of impairment of the light transmittance can inter alia be used to assess a reliability of an object recognition based on the lidar sensor and/or to issue an informational message to a user (e.g., a cleaning and/or service recommendation, etc.) and/or to activate functionally restricted operation, etc.

Preferably, according to an example embodiment of the present invention, the lidar sensor is configured to control the light sensitivity on the basis of an evaluation of an amplitude and/or a width and/or a surface and/or a time curve of the corresponding received signal components. It is also possible to control the light sensitivity at the individual pixel level and/or at the macropixel level and/or globally, i.e., for an entire detector surface.

In a further advantageous example embodiment of the present invention, in a case in which the lidar sensor is designed as a scanning lidar sensor, the evaluation unit is configured to adjust a light sensitivity in the first receiving mode and/or in the second receiving mode and/or a time for switching from the first receiving mode to the second receiving mode depending on a current rotation angle of a deflection unit of the lidar sensor. The deflection unit serves to deflect a, for example, point-shaped or line-shaped laser beam, which is generated by a stationary transmitting unit, in a horizontal and/or vertical direction in order to move the laser beam sequentially over an entire field of view of the lidar sensor. The adjustment of the light sensitivities and/or of the switching time depending on the rotation angle offers the advantage that fluctuations in the intensity of the partial reflections, which are caused by different angles of incidence on the protective glass during a scanning process of the lidar sensor, can be compensated at least partially, which ensures that a distinction between useful echoes and partial reflection echoes can be made with a high degree of reliability, regardless of a corresponding rotation angle of the deflection unit. Alternatively or additionally, it is also advantageously possible to adjust the light sensitivity in the first receiving mode and/or in the second receiving mode and/or the time for switching from the first receiving mode to the second receiving mode depending on a location and/or an extent of an impairment of a light transmittance of the protective window (e.g., caused by dirt, scratches, heating wires integrated into the protective window, etc.). This also ensures the advantage described above that a distinction between useful echoes and partial reflection echoes can be made in a substantially uniform manner.

Furthermore advantageously, according to an example embodiment of the present invention, the evaluation unit is configured to carry out a calibration of the light sensitivity of the detector for the first receiving mode and/or the second receiving mode. This is done, for example, by one or more environmental detection processes with different bias voltages in order to set an optimal bias voltage depending on the currently existing boundary conditions in each case. For example, the calibration can be considered complete if a maximum permissible threshold value for an amplitude of the signal generated in the detector is maintained and/or fallen below and/or if a distinction between partial reflection echoes and echoes from nearby objects can be made, which is ascertained, for example, on the basis of compliance with a predefined minimum detection probability for certain objects (in particular nearby objects). Furthermore, it is possible to perform such a calibration before or during a system start of the lidar sensor and/or recurrently during ongoing operation of the lidar sensor.

According to a second aspect of the present invention, a vehicle comprising a lidar sensor according to the first aspect of the present invention is proposed. The vehicle is, for example, a road vehicle (e.g., car, van, truck, motorcycle, etc.) or a rail vehicle, an aircraft/plane, or a watercraft. The lidar sensor is used, for example, in an environmental detection system of the vehicle, which can inter alia be used for partially automated and/or fully automated driving operation and/or for various driver assistance systems of the vehicle. The features, combinations of features and the advantages resulting therefrom correspond to those discussed in connection with the first-mentioned aspect of the present invention, such that reference is made to the above statements in order to avoid repetitions.

### BRIEF DESCRIPTION OF THE DRAWINGS

In the following, exemplary embodiments of the present invention are described in detail with reference to the figures.

FIG. 1 is a schematic view of an example embodiment of a lidar sensor according to the present invention.

FIG. 2 is a view of exemplary time curves of laser pulse echoes and electrical signals corresponding to them.

FIG. 3 is a schematic view of an example embodiment of a vehicle according to the present invention in connection with a lidar sensor according to the present invention.

### DETAILED DESCRIPTION OF EXAMPLE EMBODIMENTS

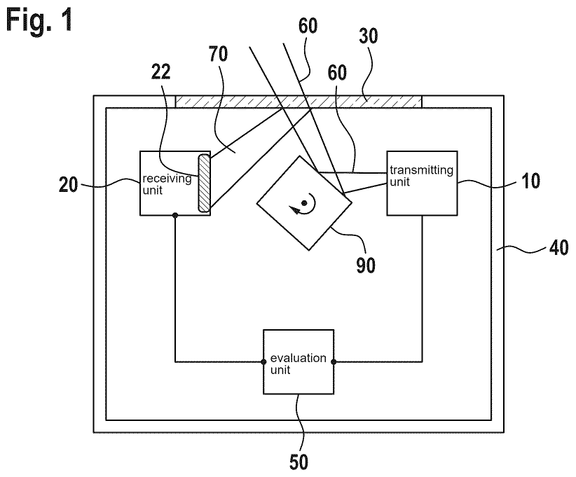

FIG. 1 shows a schematic view of an embodiment of a lidar sensor according to the present invention, which has a transmitting unit 10, a receiving unit 20, a protective window 30, a housing 40, an evaluation unit 50 and a deflection unit 90.

The transmitting unit 10, the receiving unit 20, the evaluation unit 50 and the deflection unit 90 are arranged within the housing 40 of the lidar sensor, while the protective window 30, which here is made of a transparent plastics material, is integrated into a cutout in a wall of the housing 40.

The lidar sensor is designed here as a line scanner In that the transmitting unit 10 is configured to generate a line-shaped laser pulse 60 by means of a laser diode arrangement and to deflect it into the environment via a rotational movement of the deflection unit 90 (see arrow in FIG. 1) for scanning an environment of the lidar sensor.

The evaluation unit 50, which is designed here as an ASIC, is connected by information technology to the transmitting unit 10 and the receiving unit 20 and is in this way configured to control the transmitting unit 10, in order to generate respective laser pulses 60 by means of the transmitting unit 10 at predefined times, wherein, for detecting the environment of the lidar sensor, the respective laser pulses 60 are emitted via the deflection unit 90 through the protective window 30 into the environment.

The receiving unit 20 is configured to receive through the protective window 30, by means of a detector 22, which is a SPAD-based detector here, portions of the emitted laser pulse 60 reflected in the environment, and to generate a signal corresponding to the reflected portions of the laser pulse 60.

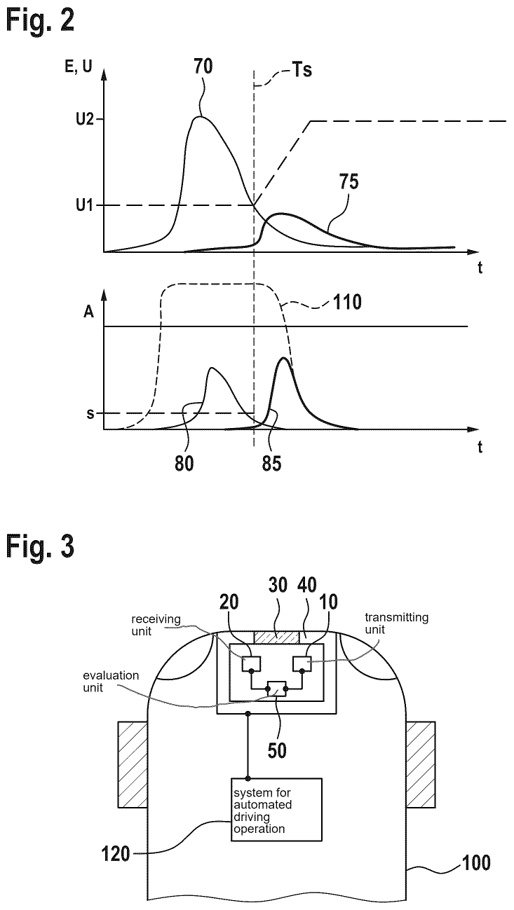

The evaluation unit 50 is furthermore configured to put the receiving unit 20 into a first receiving mode before receiving partial reflections 70 of a particular laser pulse 60, which are caused within the lidar sensor by the protective window 30. The first receiving mode here corresponds to a linear operating mode of SPAD photodiodes of the detector 22, which is set by the evaluation unit 50 by applying a corresponding first reverse bias voltage U1 (see FIG. 2) to the corresponding SPAD photodiodes of the detector 22.

The evaluation unit 50 is furthermore configured to put the receiving unit 20 into a second receiving mode at a time interval from the emission of the laser pulse 60, wherein the receiving unit 20 has a lower light sensitivity in the first receiving mode than in the second receiving mode. This is achieved in that the second receiving mode here corresponds to a Geiger operating mode of the SPAD photodiodes of the detector 22, which is set by the evaluation unit 50 by applying a corresponding second reverse bias voltage U2 (see FIG. 2) to the corresponding SPAD photodiodes of the detector 22.

The time interval from the emission of the laser pulse 60, which corresponds to the switching time from the first receiving mode to the second receiving mode, is ascertained dynamically by the evaluation unit 50 here and is present whenever amplitude values of a falling edge of the first signal components 80 of the laser pulse 60, which are reflected by the protective window 30, fall below a predefined threshold value S (see FIG. 2).

The evaluation unit 50 is also configured to receive the signal generated by the receiving unit 20 and to distinguish first signal components 80 (see FIG. 2) generated by partial reflections on the protective window 30 from second signal components 85 (see FIG. 2) which are generated by reflections on objects in the environment of the lidar sensor. The distinction between the two signal components 80, 85 takes place here on the basis of a detection threshold value for an amplitude of the signal components 80, 85, wherein the detection threshold value is advantageously a dynamically adjustable detection threshold value, which is adjusted depending on current boundary conditions (e.g., a maximum and/or an average illumination intensity present on the detector 22) in order to permanently ensure that the signal components 80, 85 can be distinguished optimally.

Particularly advantageously, the evaluation unit 50 is furthermore configured to maintain a respective predefined light sensitivity in the first receiving mode and/or in the second receiving mode by means of a control and to ascertain a degree of impairment of a light transmittance of the protective window 30 on the basis of an extent of the control. The light sensitivity is controlled here on the basis of an evaluation of a surface and of a time curve of the corresponding received signal components 80, 85.

FIG. 2 shows a view of exemplary time curves of laser pulse echoes, which result through partial reflections 70 on the protective window 30 (see FIG. 1 or FIG. 3) and through object reflections 75 on objects in the environment of the lidar sensor. In addition, exemplary curves of electrical signals 80, 85 are shown, which are generated by the receiving unit 20 (see FIG. 1 or FIG. 3) and in each case correspond to the laser pulse echoes.

The upper diagram in FIG. 2 shows curves of corresponding illumination intensities on the detector 22 (see FIG. 1) of the receiving unit 20, which are generated by the partial reflections 70 and the object reflections 75 of the laser pulse 60. In addition, this diagram shows a curve of a bias voltage which is applied to corresponding photodiodes of the detector 22, wherein the bias voltage is switched from a first bias voltage U1 to a second bias voltage U2 at a switching time Ts so that a lower light sensitivity of the detector 22 results before the switching time Ts than after the switching time Ts.

This has the result that the first signal components 80 generated by the detector 22 (see lower diagram in FIG. 2), which correspond to the reception of the partial reflections 70, and the second signal components 85 generated by the detector 22 (see lower diagram in FIG. 2) are at least partially matched to one another with regard to their respective amplitudes A. This has the effect of reducing a probability that the first signal components 80 will saturate and that, as a result, the first signal components 85 will disadvantageously overlap the second signal components 80.

For comparison, a dashed line indicates an exemplary saturated signal 110, which could be caused by the partial reflections 70 without switching the light sensitivities in the detector 22 at the switching time Ts and would thus lead to a disadvantageous overlap of the second signal components 85, as a result of which a detection of objects in the close range would not be possible or would only be possible to a limited extent.

FIG. 3 shows a schematic view of an embodiment of a vehicle 100 according to the present invention, which is designed here as a passenger car, in connection with a lidar sensor according to the present invention, wherein the lidar sensor is represented by a housing 40, a protective window 30, a transmitting unit 10, a receiving unit 20 and an evaluation unit 50, without thereby being limited to the components described above.

The lidar sensor according to the present invention is connected by information technology to a system 120 for an automated driving operation of the vehicle 100 so that the vehicle 100 is configured to receive output signals generated by the lidar sensor and to carry out automated control of the vehicle 100 on the basis of the output signals. Since, according to the present invention, the output signals of the lidar sensor contain particularly reliable information about objects in the close range of the lidar sensor, a particularly safe automated driving operation of the vehicle 100 is possible, which can relate, for example, to traffic scenarios such as merging vehicles and/or vehicles with overhanging loads, etc. in the environment of the vehicle 100 and/or to different traffic scenarios.

What is claimed is:

1. A lidar sensor, comprising:
a transmitting unit;
a receiving unit;
a protective window;
a housing; and
an evaluation unit;
wherein:
the transmitting unit and the receiving unit are arranged within the housing and the protective window is integrated into a cutout in a wall of the housing,
the transmitting unit is configured to generate a laser pulse which, for detecting an environment of the lidar sensor, is emitted through the protective window into the environment,
the receiving unit is configured to receive through the protective window, using a detector, portions of the emitted laser pulse reflected in the environment, and to generate a signal corresponding to the reflected portions of the laser pulse, and
the evaluation unit is configured to:
put the receiving unit into a first receiving mode before receiving partial reflections of a particular laser pulse, which are caused within the lidar sensor by the protective window,
put the receiving unit into a second receiving mode at a time interval from the emission of the laser pulse, wherein the receiving unit has a lower light sensitivity in the first receiving mode than in the second receiving mode, and
receive the signal generated by the receiving unit and distinguish first signal components generated by partial reflections on the protective window from second signal components which are generated by reflections on objects in the environment of the lidar sensor.

2. The lidar sensor according to claim 1, wherein:
the detector of the receiving unit (20) is a SPAD detector, and/or
the lidar sensor is a point scanner and/or as a line scanner and/or as a flash sensor.

3. The lidar sensor according to claim 1, wherein the time interval from the emission of the laser pulse is a predefined time interval which is set depending on:
a time of flight of the laser pulse, which results from a length of an optical path from the transmitting unit to the protective window and from the protective window to the receiving unit, and/or
a duration of the laser pulse and/or a time curve of the laser pulse and/or an amplitude of the laser pulse.

4. The lidar sensor according to claim 1, wherein the evaluation unit is configured to switch from the first receiving mode to the second receiving mode when amplitude values of a falling edge of the first signal components of the laser pulse, which are reflected by the protective window, fall below a predefined threshold value.

5. The lidar sensor according to claim 1, wherein the evaluation unit is configured to operate all or some of the pixels of the detector:
in the first receiving mode: (i) in a non-amplified operating mode, of (ii) in a linear operating mode, or (iii) in a Geiger operating mode or, in (iv) a mixed operating mode, and/or
in the second receiving mode: (i) in a mixed operating mode, or (ii) in the Geiger operating mode.

6. The lidar sensor according to claim 1, wherein the lidar sensor is configured to:
(i) maintain a relevant predefined light sensitivity in the first receiving mode and/or in the second receiving mode by means of a control, and/or
(ii) ascertain a degree of impairment of a light transmittance of the protective window based on an extent of the control.

7. Lidar sensor according to claim 6, wherein the lidar sensor is configured to control light sensitivity based on an evaluation of:
an amplitude, and/or
a width, and/or
a surface, and/or
a time curve of the received signal components.

8. The lidar sensor according to claim 1, wherein the lidar sensor is a scanning lidar sensor, and wherein the evaluation unit is configured to adjust a light sensitivity in the first receiving mode and/or in the second receiving mode and/or a time for switching from the first receiving mode to the second receiving mode depending on:
a current rotation angle of a deflection unit of the lidar sensor, and/or
a location and/or an extent of impairment of a light transmittance of the protective window.

9. The lidar sensor according to claim 1, wherein the evaluation unit is configured to carry out a calibration of light sensitivity of the detector for the first receiving mode and/or the second receiving mode.

10. A vehicle, comprising:
a lidar sensor, including:
a transmitting unit;
a receiving unit;
a protective window;
a housing; and
an evaluation unit;
wherein:
the transmitting unit and the receiving unit are arranged within the housing and the protective window is integrated into a cutout in a wall of the housing,
the transmitting unit is configured to generate a laser pulse which, for detecting an environment of the lidar sensor, is emitted through the protective window into the environment,
the receiving unit is configured to receive through the protective window, using a detector, portions of the emitted laser pulse reflected in the environment, and to generate a signal corresponding to the reflected portions of the laser pulse, and
the evaluation unit is configured to:
put the receiving unit into a first receiving mode before receiving partial reflections of a particular laser pulse, which are caused within the lidar sensor by the protective window,
put the receiving unit into a second receiving mode at a time interval from the emission of the laser pulse, wherein the receiving unit has a lower light sensitivity in the first receiving mode than in the second receiving mode, and
receive the signal generated by the receiving unit and distinguish first signal components generated by partial reflections on the protective window from second signal components which are generated by reflections on objects in the environment of the lidar sensor.
